(19) United States
(12) Patent Application Publication
(10) Pub. No.: US 2015/0171538 A1
(43) Pub. Date: Jun. 18, 2015

(54) CONNECTION TERMINAL

(71) Applicant: YAZAKI CORPORATION, Tokyo (JP)

(72) Inventor: Hidenori KIBUSHI, Makinohara-shi (JP)

(73) Assignee: YAZAKI CORPORATION, Tokyo (JP)

(21) Appl. No.: 14/629,529

(22) Filed: Feb. 24, 2015

Related U.S. Application Data
(63) Continuation of application No. PCT/JP2013/071665, filed on Aug. 9, 2013.

(30) Foreign Application Priority Data
Sep. 3, 2012 (JP) 2012-193008

(51) Int. Cl. H01R 13/11

(52) U.S. Cl. CPC H01R 13/114

(57) ABSTRACT

A connection terminal includes a box-shaped electrical connection part into which a tab-shaped mating connection part is inserted. The electrical connection part includes a plurality of contact parts which are formed as a single member that is continuous to the inside and makes contact with the mating connection part. The plurality of contact parts include: a pair of first contact sections disposed on the upstream side in the insertion direction of the mating connection part, and to be interpose the mating connection part so as to be in contact therewith; and a pair of second contact sections disposed on the downstream side in the insertion direction of the mating connection part, and to be interpose the mating connection part so as to be in contact therewith.

### CROSS REFERENCE TO RELATED APPLICATIONS

This application is a continuation of International Application No. PCT/JP2013/071665, filed Aug. 9, 2013, and based upon and claims the benefit of priority from Japanese Patent Application No. 2012-193008, filed Sep. 3, 2012, the entire contents of all of which are incorporated herein by reference.

### TECHNICAL FIELD

This application relates to a connection terminal.

### BACKGROUND

As a connection terminal of a conventional example, one having a box-shaped electrical connection part into which a tab-shaped mating connection part is inserted and in which the electrical connection part has a plurality of contact parts inside is known (refer to JP S55-051731 U (PTL 1)).

In this conventional connection terminal, main contact pieces and auxiliary contact pieces are formed as separate bodies on connection pieces arranged in a box-shaped case, and the connection pieces, the main contact pieces, and the auxiliary contact pieces are integrally fixed by a fixing member.

### SUMMARY

In the conventional connection terminal such as in PTL 1, circuit resistance at the contact between the mating connection part and the contact part can be reduced by making the contact points between the mating connection part and the contact part at four places as compared to two places.

However, in the conventional connection terminal such as PTL 1, since the connection pieces, the main contact pieces, and the auxiliary contact pieces are formed as separate bodies at the electrical connection part, the number of parts count was increased. In addition, the circuit resistance at the electrical connection part was increased by fixing integrally the separately formed connection pieces, main contact pieces, and auxiliary contact pieces together.

Thus, an object of the present application is to provide a connection terminal that can cut down the number of parts count and reduce the circuit resistance.

The connection terminal according to a first aspect of the present application includes a box-shaped electrical connection part into which a tab-shaped mating connection part is inserted. The electrical connection part includes a plurality of contact parts that are formed as a single member that is continuous to the inside and makes contact with the mating connection part. The plurality of contact parts include: a pair of first contact sections disposed on the upstream side in the insertion direction of the mating connection part, and to be interpose the mating connection part so as to be in contact therewith; and a pair of second contact sections disposed on the downstream side in the insertion direction of the mating connection part, and to be interpose the mating connection part so as to be in contact therewith.

In the connection terminal according to the first aspect of the present application, since the electrical connection part includes the plurality of contact parts that are formed as the single member that is continuous to the inside and makes contact with the mating connection part, it is not necessary to separately form a plurality of contact parts, and the number of parts count can be cut down. In addition, it is possible to reduce circuit resistance at the electrical connection part.

Accordingly, in the connection terminal according to the first aspect of the present application, since the plurality of contact parts are formed as the single member that is continuous at the electrical connection part, the number of parts count can be cut down and circuit resistance can be reduced.

Also, since the plurality of contact parts include the pair of first contact sections disposed on the upstream side in the insertion direction of the mating connection part, and the pair of second contact sections disposed on the downstream side in the insertion direction of the mating connection part, it is possible to select either one of the first contact sections and the second contact sections as a main flow channel for the current depending on the kind of materials the mating connection part and the connection terminal are made of

Therefore, without changing the shape of the mating connection part and the connection terminal, it is possible to modify the circuit length of the current that flows between the mating connection part and the connection terminal.

Preferably, the plurality of contact parts include a third contact section which is disposed between the pair of first contact sections and the pair of second contact sections, and which makes contact with the mating connection part.

With such configurations, the plurality of contact parts will have five contact points against the mating connection part, and it is possible to reduce the circuit resistance further.

Preferably, the connection terminal according to the first aspect of the present application further includes an elastic plate part which is elastically deformable by insertion of the mating connection part, and one of the pair of first contact sections and one of the pair of second contact sections are provided on the elastic plate part.

With such configurations, it is possible to reduce insertion force of the mating connection part while securing contact reliability between the mating connection part and the plurality of contact parts.

With the connection terminal according to the first aspect of the present application, it achieves an advantageous effect of providing a connection terminal which can cut down the number of parts count and which can reduce the circuit resistance.

### BRIEF DESCRIPTION OF DRAWINGS

FIG. 1 is a cross-sectional view of a connection terminal according to an embodiment.

FIG. 2 is a perspective view of the connection terminal according to the embodiment.

FIG. 3 is a cross-sectional view at the time when a mating connection part is not inserted into the connection terminal according to the embodiment.

### DESCRIPTION OF EMBODIMENTS

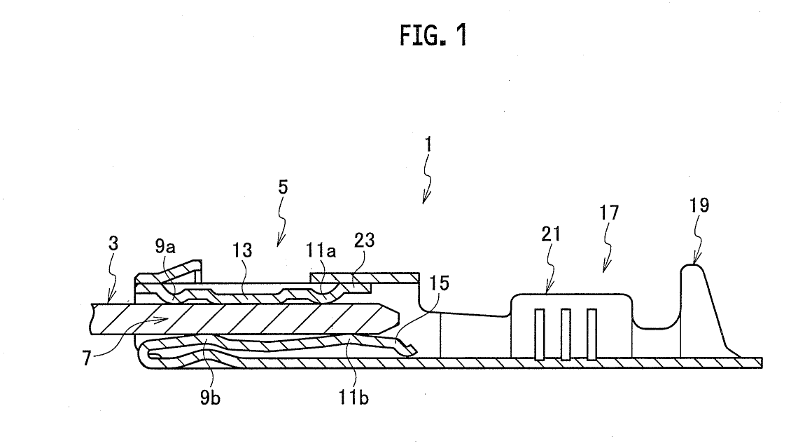

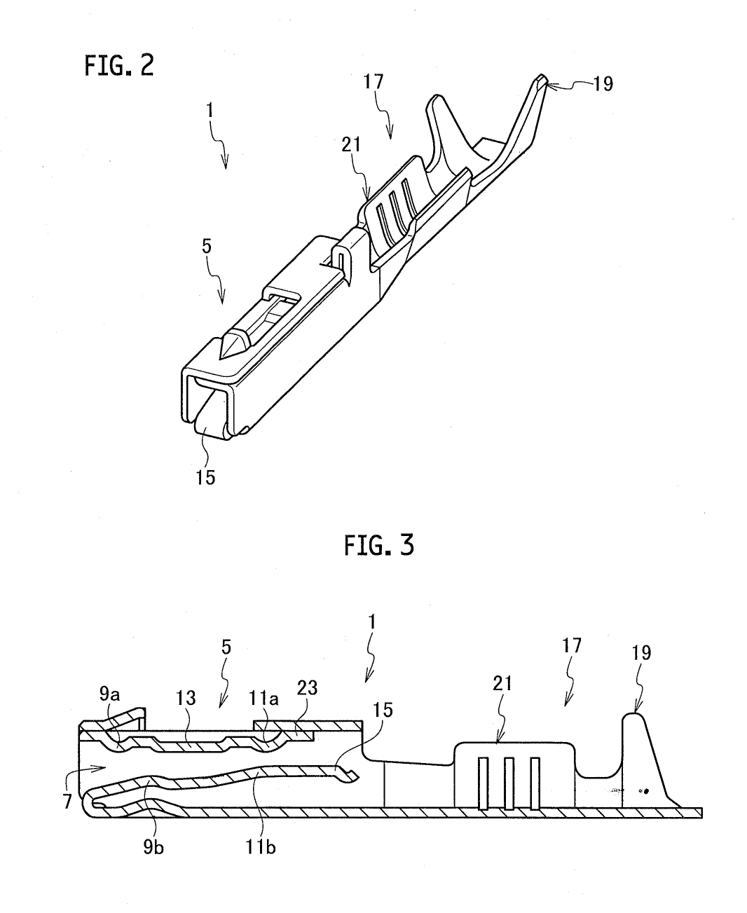

A connection terminal 1 according to an embodiment will be explained by referring to FIGS. 1 to 3.

The connection terminal 1 according to the embodiment includes a box-shaped electrical connection part 5 into which a tab-shaped mating connection part 3 is inserted.

The electrical connection part 5 includes a plurality of contact parts 7 that are formed as a single member continuous to the inside and makes contact with the mating connection part 3.

The plurality of contact parts 7 include: a pair of first contact sections 9a, 9b disposed on the upstream side in the insertion direction of the mating connection part 3, and to be interpose the mating connection part 3 so as to be in contact therewith; and a pair of second contact sections 11a, 11b disposed on the downstream side in the insertion direction of the mating connection part 3, and to be interpose the mating connection part 3 so as to be in contact therewith.

Moreover, the plurality of contact parts 7 include a third contact section 13 which is provided between the pair of first contact sections 9a, 9b and the pair of second contact sections 11a, 11b, and which contacts the mating connection part 3.

The connection terminal 1 includes an elastic plate part 15 capable of elastic deformation by insertion of the mating connection part 3. One of the first contact sections 9b and one of the second contact sections 11b are provided on the elastic plate part 15.

The connection terminal 1 is composed of a sheet of electrically conductive plate, and includes a cable crimping part 17 and an electrical connection part 5 each formed by folding the plate. The cable crimping part 17 includes a jacket crimp portion 19 and a core wire crimp portion 21.

The jacket crimp portion 19 includes a pair of crimping pieces, and at a terminal part of a cable (not illustrated) which is connected to an equipment and the like, the cable and the connection terminal 1 are integrally fixed by crimping a jacket of the cable. The core wire crimp portion 21 includes a pair of crimping pieces provided between the electrical connection part 5 and the jacket crimp portion 19, and at the terminal part of the cable, the cable and the connection terminal 1 are electrically connected by crimping a core wire part exposed from the jacket of the cable.

The electrical connection part 5 is formed as a single member whose base plate is continuous from that of the cable crimping part 17, and includes a female connection part formed in a box-shape by folding. The male-type mating connection part 3 of a mating terminal (not illustrated) formed in the tab-shape is inserted into the electrical connection part 5. Inside the electrical connection part 5, the plurality of contact parts 7 that contact the mating connection part 3 are provided and the mating terminal and the connection terminal 1 are electrically connected.

In the embodiment, the plurality of contact parts 7 include five contact points of: the pair of first contact sections 9a, 9b, the pair of second contact sections 11a, 11b, and the third contact section 13. The pair of first contact sections 9a, 9b are disposed on the upstream side in the insertion direction of the mating connection part 3 at the electrical connection part 5. The first contact section 9a located on the upper side is formed as a single member continuous from a top plate 23 and is protruded inward of the electrical connection part 5.

The elastic plate part 15 is formed by folding the base plate toward inside of the electrical connection part 5. The first contact section 9b disposed on the lower side is formed as a single member continuous from the elastic plate part 15 and is protruded inward of the electrical connection part 5. The elastic plate part 15 is provided so as to be elastically deformable toward the base plate by insertion of the mating connection part 3 into the electrical connection part 5.

When the mating connection part 3 is inserted into the electrical connection part 5, the first contact sections 9a, 9b contact the upper and lower faces on the base side of the mating connection part 3, thereby electrically connecting the mating terminal with the connection terminal 1.

The second contact sections 11a, 11b are disposed on the downstream side in the insertion direction of the mating connection part 3 at the electrical connection part 5. The second contact section 11a disposed on the upper side is formed as a single member continuous from the top plate 23 and is protruded inward of the electrical connection part 5.

The second contact section 11b disposed on the lower side is formed as a single member continuous from the elastic plate part 15 and is protruded inward of the electrical connection part 5.

When the mating connection part 3 is inserted into the electrical connection part 5, the second contact sections 11a, 11b contact the upper and lower faces on the tip side of the mating connection part 3, thereby electrically connecting the mating terminal with the connection terminal 1.

The third contact section 13 is formed as a single member continuous from the top plate 23 between the first contact section 9a and the second contact section 11a at the electrical connection part 5, and is protruded inwardly of the electrical connection part 5. When the mating connection part 3 is inserted into the electrical connection part 5, the third contact section 13 contacts the upper face at the center of the mating connection part 3, thereby electrically connecting the mating terminal with the connection terminal 1.

Depending on the kind of the materials of the mating connection part 3 and the connection terminal 1, among the plurality of contact parts 7, either one of the first contact sections 9 and the second contact sections 11 can be selected as a main flow channel for the current.

More specifically, for example when the mating connection part 3 and the connection terminal 1 are similar metal formed with copper alloy, the first contact sections 9a, 9b with which the circuit length between the mating connection part 3 and the connection terminal 1 is short become the main flow channel where a large current flows.

On the other hand, for example when the mating connection part 3 is formed with copper alloy and the connection terminal 1 is a different metal made of stainless steel that has a higher specific resistance than that of the copper alloy, since a large current flows longer in the mating connection part 3 which has a lower circuit resistance, the second contact sections 11a, 11b become the main flow channel.

As such, in the embodiment, since the main flow channel can be selected, it is possible to change the circuit length of the current that flows between the mating connection part 3 and the connection terminal 1 without changing the shape of the mating connection part 3 and the connection terminal 1. Further, the contact section which is not selected as the main flow channel becomes a sub flow channel in which a low current flows.

At the connection terminal 1, the electrical connection part 5 includes the plurality of contact parts 7 formed as a single member which is continuous to the inside and which contact the mating connection part 3. Therefore, it is not necessary to form the plurality of contact parts 7 separately from the electrical connection part 5, and it is possible to cut down the number of parts count, and in addition, the circuit resistance at the electrical connection part 5 can be reduced.

At the connection terminal 1, the plurality of contact parts 7 are formed as a single member continuous at the electrical connection part 5. Therefore, the number of parts count can be cut down and the circuit resistance can be reduced.

The plurality of contact parts 7 include the pair of first contact sections 9a, 9b disposed on the upstream side in the insertion direction of the mating connection part 3, and the pair of second contact sections 11a, 11b disposed on the downstream side in the insertion direction of the mating connection part 3. Therefore, depending on the kind of the materials the mating connection part 3 and the connection terminal 1 are made of, either one of the first contact sections 9a, 9b and the second contact sections 11a, 11b can be selected as a main flow channel for the current.

Therefore, it is possible to change the circuit length of the current that flows between the mating connection part 3 and the connection terminal 1 without changing the shape of the mating connection part 3 and the connection terminal 1.

The plurality of contact parts 7 include a third contact section 13 which is disposed between the pair of first contact sections 9a, 9b and the pair of second contact sections 11a, 11b, and which contacts the mating connection part 3. Therefore, the plurality of contact parts 7 will have five contact points against the mating connection part 3, and it is possible to reduce the circuit resistance further.

One of the first contact sections 9b and one of the second contact sections 11b are provided on the elastic plate part 15 which is elastically deformable by insertion of the mating connection part 3. Therefore, it is possible to reduce insertion force of the mating connection part 3 while securing contact reliability between the mating connection part 3 and the plurality of contact parts 7.

In the connection terminal 1 of the embodiment, the connection terminal 1 is crimped to the cable so as to be electrically connected. However, it is not limited to this but the conduction member to which the connection terminal 1 is connected can be anything; for example, the connection terminal 1 may be electrically connected to a conductor of the an electrical circuit substrate.

Moreover, in the embodiment, the plurality of contact parts 7 has five contact points against the mating connection part 3. However, the number is not limited to this, but it can be more than five contact points or it can be four contact points.

What is claimed is:

1. A connection terminal, comprising:
a box-shaped electrical connection part into which a tab-shaped mating connection part is inserted,
the electrical connection part comprising a plurality of contact parts which is formed as a single member continuous to the inside and which makes contact with the mating connection part,
the plurality of contact parts comprising: a pair of first contact sections disposed on the upstream side in an insertion direction of the mating connection part, and to be interpose the mating connection part so as to be in contact therewith; and a pair of second contact sections disposed on the downstream side in the insertion direction of the mating connection part, and to be interpose the mating connection part so as to be in contact therewith.

2. The connection terminal according to claim 1, wherein
the plurality of contacts comprises a third contact section disposed between the pair of first contact sections and the pair of second contact sections, the third contact section making contact with the mating connection part.

3. The connection terminal according to claim 1, further comprising:
an elastic plate part that is elastically deformable by insertion of the mating connection part,
one of the pair of first contact sections and one of the pair of second contact sections provided on the elastic plate part.

4. The connection terminal according to claim 2, further comprising:
an elastic plate part that is elastically deformable by insertion of the mating connection part,
one of the pair of first contact sections and one of the pair of second contact sections provided on the elastic plate part.
